(19) United States
(12) Patent Application Publication
(10) Pub. No.: US 2007/0261903 A1
(43) Pub. Date: Nov. 15, 2007

(54) AIR INTAKE SCREEN WITH A POLYMER FRAME FOR A VEHICLE

(75) Inventors: Bradley R. Holloway, New Haven, IN (US); Mark D. Oberly, Muncie, IN (US); Kenneth J. Sperone, Fort Wayne, IN (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(73) Assignee: International Truck Intellectual Property Company,, Warrenville, IL (US)

(21) Appl. No.: 11/382,545

(22) Filed: May 10, 2006

(51) Int. Cl. B60K 11/00

(52) U.S. Cl. 180/68.1

(57) ABSTRACT

An air intake screen protects the cooling system of motor vehicles from insects and other debris, especially for medium and heavy duty trucks and buses. The air intake screen has the perimeter of an interior mesh embedded in a solid frame. The frame is preferably a polymer.

### BACKGROUND OF THE INVENTION

1. Field of the Invention

The present invention relates to an air intake screen for preventing the passage therethrough of insects, mud and other debris, for use with motor vehicles, especially medium to heavy duty trucks and buses.

2. Description of the Prior Art

The internal combustion engine of a motor vehicle generates large quantities of heat during use. Air-cooled or liquid-cooled cooling systems remove the generated heat from the engine and other components of a motor vehicle.

One liquid cooling system uses a radiator in a coolant circuit with the engine for cooling a coolant or cooling water, and a water pump or a flow control valve to control the flow rate of the coolant that passes through the radiator. A flow control valve typically opens in response to a control signal from an electronic controller module to circulate cooling water from the radiator with the water pump through tubing into coolant passages in the block and heads of the engine. The cooling water receives heat from the engine, then returns to the radiator.

In such a cooling water system, a sensor detects the temperature of cooling water within the engine. A frontally placed radiator transfers heat from the circulating coolant by conductive transfer to ambient air flowing through the radiator. The frontal placement of the radiator takes advantage of ram air for forcing ambient air through the radiator when the truck is driven forward.

Unfortunately, the frontal placement of the radiator also makes the radiator vulnerable to debris, such as insects and mud. A large build-up of insects, for example, can interfere with heat exchange and reduce the efficiency of the cooling system.

Air intake screens are therefore used to prevent damage to the heat exchanger or radiator from insects and other debris. While a build-up of insects and other debris on the air intake screen can reduce the heat exchange, such screens are more easily cleaned to remove the build-up than the radiator. A simple wash removes the debris and restores the cooling system to a higher efficiency.

Prior art air intake screens typically use a metal frame, although a leather border has been used along the perimeter of the screen. A metal frame typically has a U-shaped channel. Screens are often first assembled to a spline, then the screen and spline assembly inserts into the frame's U-shaped channel. After insertion of the mesh, with or without a spline, the metal frame can be crimped to fasten the mesh within the frame. The metal frame can also be hole-punched for fastening within the motor vehicle. Leather or cloth frames are simply stitched to the screen.

In modern streamlined and less heavy medium and heavy duty trucks, the metal frames tend to be thin to reduce both the weight and cost of the frame. During assembly it is difficult, however, to quickly and accurately install the screen within the frame. Additionally, it is difficult to accurately punch any holes at the edge of such a narrow frame. If the holes do not align well for fastening the assembled air intake screen to the vehicle or are punched off the edge, the air intake screen is wasted.

The current air intake screens are not durable. The metal frames are susceptible to fatigue and corrosion, leather and cloth borders to rotting. The mesh in the frames is prone to unraveling.

Furthermore, streamlined trucks have curved front ends. These curves require parts to be curved as well in order to fit within the crowded confines of the engine compartment. Assembling a metal screen with a straight and narrow frame is difficult enough to assemble accurately. Assembling a metal screen with curved edges to a narrow curved frame is extremely difficult to accurately assemble in a cost efficient manner.

Therefore, it would be advantageous to develop an air intake screen requiring less time to assemble without reducing the accuracy during assembly. It would also be an advantage to develop an air intake screen that is light weight, durable and easy to handle. It would be a further advantage to develop an air intake screen that can easily conform to different shapes, such as curves, to fit better in streamlined vehicles.

### SUMMARY OF THE INVENTION

According to the invention there is provided an air intake screen for motor vehicles, especially medium and heavy duty trucks and buses. The air intake screen has the perimeter of an interior mesh embedded in a solid frame. The frame is preferably a polymer.

Additional effects, features and advantages will be apparent in the written description that follows.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a partial view of a motor vehicle with the air intake screen of the invention;

FIG. 2 is a front plan view of an air intake screen of the invention; and

FIG. 3 is a partial view of a motor vehicle with the air intake screen of the invention.

### DETAILED DESCRIPTION OF THE INVENTION

Turning to the figures where like reference numerals refer to like structures,

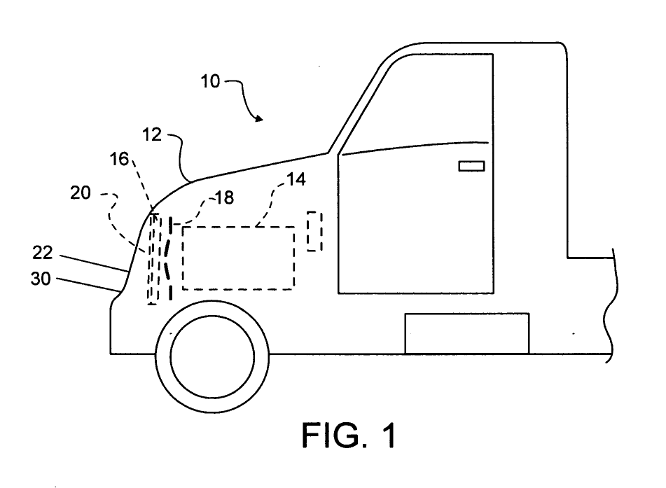

FIG. 1 shows a front portion of a motor vehicle 10, such as a truck, having an engine compartment 12 housing an engine 14. The engine is coupled through a drivetrain to drive wheels (not shown) for moving the truck when driven. Engine 14 is shown by way of example as a diesel engine having its own liquid cooling system. Coolant circulates through coolant passages in the block and heads of engine 14 that form the engine combustion chambers.

Some of the heat of combustion created in the engine combustion chambers radiates to the coolant circulating in a circuit in the cooling system. The cooling system has coolant circulating through a circuit between a radiator 16 and the engine 14. Such fluids are typically water or water based. Tubing is in fluid communication with the radiator 16 and connects the motor engine 14 with the radiator 16. A pump in fluid communication with the radiator 16 helps circulate the coolant through the cooling system 13. The frontally placed radiator 16 transfers heat from the circulating coolant by conductive transfer to ambient air flowing through the radiator 16. The frontal placement of the radiator 16 takes advantage of ram air flowing through a grille 22 disposed in an opening in the front end 30 of the engine compartment 12. Ram air forces ambient air through the radiator 16 when the truck 10 is driven forward. Because ram air flow may at times be insufficient for adequate heat transfer, an engine cooling fan 18 associated with the radiator 16 draws ambient air through the radiator 16.

An air intake screen 20 is located forward the radiator in the engine compartment 12 and behind the grille 22 of the motor vehicle 10. The air intake screen 20 has an interior mesh 24 with a perimeter embedded in a solid polymer frame. Preferably, the frame 26 is a polymer, such as an elastomer like hard rubber, or a thermoset or thermoplastic polymer like polyurethane. The polymer used should allow the frame to be flexible for bending if desired. Yet the frame should be sufficiently rigid for it to be punched or drilled. The type of polymer used for the frame can change, depending on the application and location of the air intake screen. The mesh 24 is preferably metal or wire.

The frame can be made by injection molding or using a gravity feed. The air intake screen, for example, can be made after first cutting the mesh to the desired shape. The outer edges of the mesh can be sealed before molding to prevent polymer bleeding into the mesh, although small amounts of bleeding into the mesh is acceptable. Then, the perimeter of the mesh can be placed in a mold or trough. The frame material is next dispensed into the trough and allowed to cure or solidify. Once solidified, the air intake screen is pulled from the mold. Alternatively the frame material, such as a thermoplastic polymer, could be extruded directly onto the perimeter of the mesh. The frame material could then be pressed through the mesh to complete the frame and allowed to harden. Using either method can produce a solid one-piece frame embedding the mesh.

The air intake screen 20 can have holes 28 in the frame 26. The holes 28 are drilled or preferably punched or stamped into the frame 26 after the frame 26 solidifies. Alternatively, the holes 28 can form when the frame 26 is molded. Other structures can be formed during the molding process as well, such as an eyelet to attaching the air intake screen to the motor vehicle.

If desired, a spline or other reinforcing border can be attached to the mesh before molding the frame onto the mesh. The spline would allow the use of a less rigid polymer and can reinforce the frame.

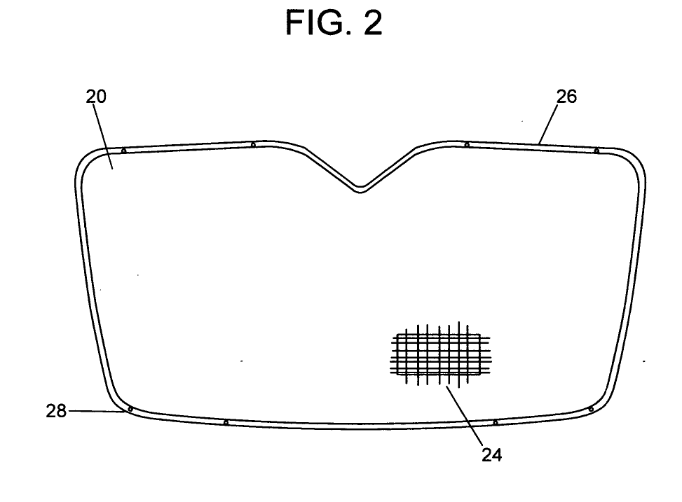

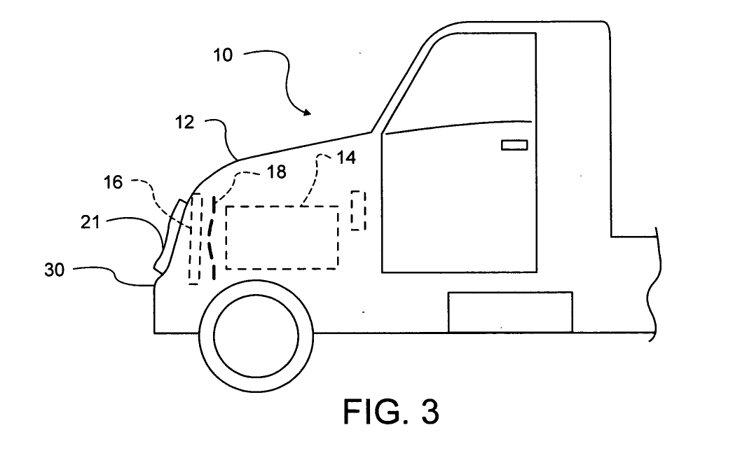

The frame 26 of the air intake screen 20 can be curved (FIG. 2). The air intake screen 21 of the invention can also be adapted to fit nonplanar surfaces, such as in front (FIG. 3) or behind a curved grille in the front of the engine compartment. The mesh and frame are made nonplanar by bending the mesh and using a nonplanar mold for the frame. Because air intake screens with designs are popular, the air intake screen 21 could be manufactured with a design for aftermarket use for fitting to the front of the grille.

The air intake screen of the invention has a number of advantages. The air intake screen is easy to accurately assemble, only requiring placing the mesh into a mold. The assembler does not need to insert the mesh into a spline then into the frame or insert the mesh directly into a U-channel frame. The mesh can be inserted into a mold, then the unpolymerized polymer can be injected into the mold. After polymerization, the mold can be removed and the air intake screen is ready for use or for punching holes into the solid frame. This manufacturing process could be automated.

The air intake screen of the invention is also light weight, durable and easy to handle. Because the frame is flexible, it can be bent to more easily fit into the narrow confines of the engine compartment. Yet, the stiffness of the frame can be tailored for use, depending on the properties of polymer used for the frame material.

The air intake screen of the invention can easily conform to different shapes, such as curves, to better adapt to their use in streamlined vehicles. The air intake screen can have a curved perimeter or irregularly shaped perimeter. The air intake screen is not limited to fitting planar surfaces, but can be curved to conform to a curved surface, such as the exterior of the grille for aftermarket uses.

The air intake screen of the invention has superior resistance to unraveling, fatigue and corrosion. Depending on the manufacturing process, the frame can be seamless.

While the invention is shown in only one of its forms, it is not thus limited but is susceptible to various changes and modifications without departing from the spirit and scope of the invention.

What is claimed is:

1. An air intake screen for a motor vehicle, comprising:
a solid polymer frame; and
an interior mesh having a perimeter embedded in the frame.

2. An air intake screen for a motor vehicle of claim 1, wherein the frame is flexible and the mesh is metal.

3. An air intake screen for a motor vehicle of claim 2, wherein the frame is a one-piece frame.

4. An air intake screen for a motor vehicle of claim 3, wherein the frame is curved, and the frame and the mesh are planar.

5. An air intake screen for a motor vehicle of claim 4, wherein the frame and the mesh are nonplanar.

6. An air intake screen for a motor vehicle of claim 5, wherein the frame is curved.

7. An air intake system for a motor vehicle, comprising:
an engine compartment having a front end;
a grill being disposed within an opening in the front end;
a radiator being located forward in the engine compartment and behind the grill; and
an air intake screen being located forward the radiator, the air intake screen comprising a solid polymer frame, and an interior mesh having a perimeter embedded in the frame.

8. An air intake system for a motor vehicle of claim 7, wherein the frame is flexible and the mesh is metal.

9. An air intake system for a motor vehicle of claim 8, wherein the frame is a one-piece frame.

10. An air intake system for a motor vehicle of claim 9, wherein the frame is curved, and the frame and the mesh are planar.

11. An air intake system for a motor vehicle of claim 9, wherein the frame and the mesh are nonplanar.

12. An air intake system for a motor vehicle of claim 11, wherein the frame is curved.

13. An air intake system for a motor vehicle of claim 9, wherein the air intake screen is located between the grill and the radiator.

14. An air intake system for a motor vehicle of claim 13, wherein the frame is curved, and the frame and the mesh are planar.

15. An air intake system for a motor vehicle of claim 13, wherein the frame and the mesh are nonplanar.

16. An air intake system for a motor vehicle of claim 15, wherein the frame is curved.
